(19) United States
(12) Patent Application Publication
(10) Pub. No.: US 2026/0322286 A1
(43) Pub. Date: Oct. 15, 2026

(54) POWER CONVERSION CIRCUIT

(71) Applicant: Murata Manufacturing Co., Ltd., Nagaokakyo-shi (JP)

(72) Inventors: Yuki ISHIKURA, Nagaokakyo-shi (JP); Chinmay BHAGAT, Nagaokakyo-shi (JP); Yuta YAMAMOTO, Nagaokakyo-shi (JP)

(73) Assignee: Murata Manufacturing Co., Ltd., Nagaokakyo-shi (JP)

(21) Appl. No.: 19/695,079

(22) Filed: Jun. 2, 2026

Related U.S. Application Data
(63) Continuation of application No. PCT/JP2024/038679, filed on Oct. 30, 2024.

(30) Foreign Application Priority Data
Dec. 28, 2023 (JP) 2023-222095

(51) Int. Cl. H02M 7/217; H02M 1/12; H02M 1/14; H02M 1/34; H02M 7/00; H02M 7/219

(52) U.S. Cl. CPC H02M 7/2173; H02M 1/126; H02M 1/14; H02M 1/348; H02M 7/003; H02M 7/219

(57) ABSTRACT

A power conversion circuit includes a switching circuit having a first series circuit, a second series circuit, and a third series circuit connected in parallel. Each series circuit includes a high-side bidirectional switching element and a low-side bidirectional switching element. The power conversion circuit includes a first filter capacitor, a second filter capacitor, and a third filter capacitor connected to the first, second, and third series circuits, respectively. An inductor and a primary-side coil of a transformer are connected to output terminals of the switching circuit. A rectifier circuit is connected to a secondary-side coil of the transformer, and an output smoothing circuit connected to the rectifier circuit. First, second, and third RC series circuits are connected between adjacent nodes of the first, second, and third series circuits, respectively.

### CROSS-REFERENCE TO RELATED APPLICATIONS

This application is a continuation of International Application No. PCT/JP2024/038679, filed on Oct. 30, 2024, which claims priority to Japanese Patent Application No. 2023-222095, filed on Dec. 28, 2023, the entire disclosures of which are incorporated herein by reference.

### TECHNICAL FIELD

The present disclosure relates to a conversion circuit that converts three-phase alternating current (AC) power to direct current (DC) power and outputs the DC power.

### BACKGROUND ART

Patent Document 1 discloses a power converter that directly converts three-phase AC power to DC power. The power converter disclosed in Patent Document 1 includes a converter circuit and a plurality of filter capacitors.

The converter circuit includes a plurality of switching elements that are connected to respective phases R, S, and T of three-phase AC power and allow current to flow in both directions. The plurality of filter capacitors reduce noise on three-phase AC power lines and are connected to the input side of the converter circuit.

In the power converter disclosed in Patent Document 1, the plurality of filter capacitors are disposed at the vertices of a triangle in a plane parallel to a mounting surface on which the plurality of switching elements are mounted, thereby reducing wiring distances between the filter capacitors and the switching elements.

### CITATION LIST

### Patent Document

Patent Document 1: Japanese Unexamined Patent Application Publication No. 2012-253855

### SUMMARY

A power conversion circuit according to an embodiment of the present invention includes a switching circuit including a first series circuit, a second series circuit, and a third series circuit connected in parallel. The first series circuit includes a first high-side bidirectional switching element and a first low-side bidirectional switching element, the second series circuit includes a second high-side bidirectional switching element and a second low-side bidirectional switching element, and the third series circuit includes a third high-side bidirectional switching element and a third low-side switching element. The power conversion circuit includes a first filter capacitor connected to the first series circuit, a second filter capacitor connected to the second series circuit, and a third filter capacitor connected to the third series circuit. The power conversion circuit includes an inductor and a primary-side coil of a transformer that are connected to respective output terminals of the switching circuit, a rectifier circuit connected to a secondary-side coil of the transformer, an output smoothing circuit connected to the rectifier circuit, and a first RC series circuit, a second RC series circuit, and a third RC series circuit.

The first filter capacitor is connected to a first node at which the first high-side bidirectional switching element and the first low-side bidirectional switching element in the first series circuit are connected to each other. The second filter capacitor is connected to a second node at which the second high-side bidirectional switching element and the second low-side bidirectional switching element in the second series circuit are connected to each other. The third filter capacitor is connected to a third node at which the third high-side bidirectional switching element and the third low-side bidirectional switching element in the third series circuit are connected to each other.

The first RC series circuit is connected between the first node and the second node. The second RC series circuit is connected between the second node and the third node. The third RC series circuit is connected between the third node and the first node.

In this configuration, a transient high-frequency component of switching current generated when the operating mode of the switching circuit is switched flows into the first RC series circuit, the second RC series circuit, and the third RC series circuit to be suppressed. Thus, a transient high-frequency component of switching current is suppressed while noise in input power is suppressed by a plurality of filter capacitors.

### BRIEF DESCRIPTION OF DRAWINGS

FIG. 1 is a circuit diagram of a power conversion circuit according to an embodiment of the present invention.

FIG. 2 is a diagram illustrating an example of a switching current generated in the power conversion circuit according to the embodiment of the present invention.

FIGS. 3A and 3B are waveform diagrams illustrating the effect of suppressing voltage ringing.

FIG. 4 is a plan view illustrating a first example of the physical configuration of the power conversion circuit according to the embodiment of the present invention.

FIG. 5 is a plan view illustrating a second example of the physical configuration of the power conversion circuit according to the embodiment of the present invention.

FIG. 6 is a plan view illustrating a third example of the physical configuration of the power conversion circuit according to the embodiment of the present invention.

### DESCRIPTION OF EMBODIMENTS

In a power converter on the order of kilowatts, filter capacitors with large capacitance may be used. However, the inventors have recognized that, as the capacitance of each filter capacitor increases, the equivalent series inductance (ESL) of the filter capacitor also increases, thereby making it difficult to suppress voltage ringing generated during switching operation of the switching elements.

The inventors have further discovered that connecting RC series circuits between the midpoint nodes of the switching circuit legs, in close proximity to the switching elements, provides a low-impedance current path for transient high-frequency switching current, thereby reducing parasitic inductance in the switching loop and suppressing voltage ringing without compromising the noise suppression function of the filter capacitors.

The present disclosure is directed to providing a power conversion device in which both suppression of noise in input power and suppression of voltage ringing generated due to switching operation are achieved.

A power conversion circuit according to an embodiment of the present disclosure will be described with reference to the drawings.

### Circuit Configuration 1 of Power Conversion Circuit

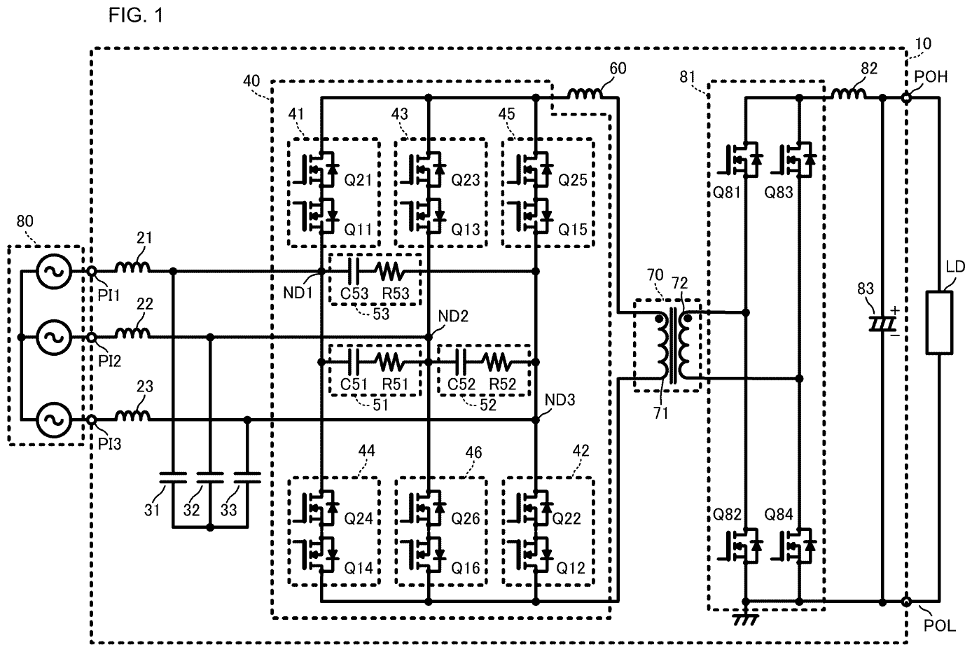

FIG. 1 is a circuit diagram of a power conversion circuit according to an embodiment of the present disclosure. As illustrated in FIG. 1, a power conversion circuit 10 includes a plurality of input terminals PI1, PI2, and PI3, a high-side direct current (DC) output terminal POH, and a low-side DC output terminal POL.

A three-phase alternating current (AC) power supply 80 is connected to the plurality of input terminals PI1, PI2, and PI3. Voltages and currents of the respective phases input to the input terminals PI1, PI2, and PI3 have predetermined phase differences. Input voltages at the input terminals PI1, PI2, and PI3 range, for example, from about 200 V to about 500 V, and input currents at the input terminals PI1, PI2, and PI3 are about 30 A. That is, power on the order of kilowatts is input to the power conversion circuit 10. The power conversion circuit 10 converts the three-phase AC power to DC power having a predetermined voltage and a predetermined current and outputs the DC power to a load LD connected to the high-side DC output terminal POH and the low-side DC output terminal POL.

The power conversion circuit 10 includes a plurality of filter inductors 21 to 23 (filter inductor 21, filter inductor 22, filter inductor 23), a plurality of filter capacitors 31 to 33 (filter capacitor 31, filter capacitor 32, filter capacitor 33), a switching circuit 40, a plurality of snubber circuits 51 to 53 (snubber circuit 51, snubber circuit 52, snubber circuit 53), a resonant inductor 60, an isolation transformer 70, a rectifier circuit 81, an output smoothing inductor 82, and an output smoothing capacitor 83.

For example, the filter capacitor 31 corresponds to “first filter capacitor”, the filter capacitor 32 corresponds to “second filter capacitor”, and the filter capacitor 33 corresponds to “third filter capacitor”. The filter capacitor 31, the filter capacitor 32, and the filter capacitor 33 have a similar configuration.

The snubber circuit 51 corresponds to “first RC series circuit”, the snubber circuit 52 corresponds to “second RC series circuit”, and the snubber circuit 53 corresponds to “third RC series circuit”. The snubber circuit 51, the snubber circuit 52, and the snubber circuit 53 have a similar configuration.

The switching circuit 40 includes a plurality of high-side bidirectional switching elements 41, 43, and 45 (high-side bidirectional switching element 41, high-side bidirectional switching element 43, high-side bidirectional switching element 45), and a plurality of low-side bidirectional switching elements 42, 44, and 46 (low-side bidirectional switching element 42, low-side bidirectional switching element 44, low-side bidirectional switching element 46).

For example, the high-side bidirectional switching element 41 corresponds to “first high-side bidirectional switching element”, the high-side bidirectional switching element 43 corresponds to “second high-side bidirectional switching element”, and the high-side bidirectional switching element 45 corresponds to “third high-side bidirectional switching element”. The low-side bidirectional switching element 44 corresponds to “first low-side bidirectional switching element”, the low-side bidirectional switching element 46 corresponds to “second low-side bidirectional switching element”, and the low-side bidirectional switching element 42 corresponds to “third low-side bidirectional switching element”.

The high-side bidirectional switching element 41 includes switching elements Q11 and Q21, each of which is a power semiconductor. A source terminal of the switching element Q11 is connected to a source terminal of the switching element Q21.

The low-side bidirectional switching element 44 includes switching elements Q14 and Q24, each of which is a power semiconductor. A source terminal of the switching element Q14 is connected to a source terminal of the switching element Q24.

The high-side bidirectional switching element 41 and the low-side bidirectional switching element 44 are connected in series to constitute a first series circuit. More specifically, a drain terminal of the switching element Q11 of the high-side bidirectional switching element 41 is connected to a drain terminal of the switching element Q24 of the low-side bidirectional switching element 44, thereby constituting the first series circuit including the high-side bidirectional switching element 41 and the low-side bidirectional switching element 44.

The high-side bidirectional switching element 43 includes switching elements Q13 and Q23, each of which is a power semiconductor. A source terminal of the switching element Q13 is connected to a source terminal of the switching element Q23.

The low-side bidirectional switching element 46 includes switching elements Q16 and Q26, each of which is a power semiconductor. A source terminal of the switching element Q16 is connected to a source terminal of the switching element Q26.

The high-side bidirectional switching element 43 and the low-side bidirectional switching element 46 are connected in series to constitute a second series circuit. More specifically, a drain terminal of the switching element Q13 of the high-side bidirectional switching element 43 is connected to a drain terminal of the switching element Q26 of the low-side bidirectional switching element 46, thereby constituting the second series circuit including the high-side bidirectional switching element 43 and the low-side bidirectional switching element 46.

The high-side bidirectional switching element 45 includes switching elements Q15 and Q25, each of which is a power semiconductor. A source terminal of the switching element Q15 is connected to a source terminal of the switching element Q25.

The low-side bidirectional switching element 42 includes switching elements Q12 and Q22, each of which is a power semiconductor. A source terminal of the switching element Q12 is connected to a source terminal of the switching element Q22.

The high-side bidirectional switching element 45 and the low-side bidirectional switching element 42 are connected in series to constitute a third series circuit. More specifically, a drain terminal of the switching element Q15 of the high-side bidirectional switching element 45 is connected to a drain terminal of the switching element Q22 of the low-side bidirectional switching element 42, thereby constituting the third series circuit including the high-side bidirectional switching element 45 and the low-side bidirectional switching element 42.

The first series circuit including the high-side bidirectional switching element 41 and the low-side bidirectional switching element 44, the second series circuit including the high-side bidirectional switching element 43 and the low-side bidirectional switching element 46, and the third series circuit including the high-side bidirectional switching element 45 and the low-side bidirectional switching element 42 are connected in parallel.

More specifically, a drain terminal of the switching element Q21 of the high-side bidirectional switching element 41, a drain terminal of the switching element Q23 of the high-side bidirectional switching element 43, and a drain terminal of the switching element Q25 of the high-side bidirectional switching element 45 are connected to each other.

A drain terminal of the switching element Q14 of the low-side bidirectional switching element 44, a drain terminal of the switching element Q16 of the low-side bidirectional switching element 46, and a drain terminal of the switching element Q12 of the low-side bidirectional switching element 42 are connected to each other.

One terminal of the filter inductor 21 is connected to the input terminal PI1. The other terminal of the filter inductor 21 is connected to a connection point (first node ND1) between the high-side bidirectional switching element 41 and the low-side bidirectional switching element 44 in the first series circuit.

One terminal of the filter inductor 22 is connected to the input terminal PI2. The other terminal of the filter inductor 22 is connected to a connection point (second node ND2) between the high-side bidirectional switching element 43 and the low-side bidirectional switching element 46 in the second series circuit.

One terminal of the filter inductor 23 is connected to the input terminal PI3. The other terminal of the filter inductor 23 is connected to a connection point (third node ND3) between the high-side bidirectional switching element 45 and the low-side bidirectional switching element 42 in the third series circuit.

One terminal of the filter capacitor 31 is connected to the first node. One terminal of the filter capacitor 32 is connected to the second node. One terminal of the filter capacitor 33 is connected to the third node.

The other terminal of the filter capacitor 31, the other terminal of the filter capacitor 32, and the other terminal of the filter capacitor 33 are connected to each other.

The power conversion circuit 10 includes the filter inductor 21, the filter inductor 22, the filter inductor 23, the filter capacitor 31, the filter capacitor 32, and the filter capacitor 33, thereby suppressing high-frequency noise contained in the input power.

In the present embodiment, the filter capacitor 31, the filter capacitor 32, and the filter capacitor 33 are star-connected; however, they may be Δ-connected. In a delta-connected configuration, one terminal of the first filter capacitor 31 is connected to the first node ND1 and the other terminal is connected to the second node ND2, one terminal of the second filter capacitor 32 is connected to the second node ND2 and the other terminal is connected to the third node ND3, and one terminal of the third filter capacitor 33 is connected to the third node ND3 and the other terminal is connected to the first node ND1.

The snubber circuit 51 is a series circuit including a resistive element R51 and a capacitor C51. The snubber circuit 51 is connected between the first node ND1 and the second node ND2. The snubber circuit 51 may also be connected in parallel with the filter capacitor 31.

The snubber circuit 52 is a series circuit including a resistive element R52 and a capacitor C52. The snubber circuit 52 is connected between the second node ND2 and the third node ND3. The snubber circuit 52 may also be connected in parallel with the filter capacitor 32.

The snubber circuit 53 is a series circuit including a resistive element R53 and a capacitor C53. The snubber circuit 53 is connected between the third node ND3 and the first node ND1. The snubber circuit 53 may also be connected in parallel with the filter capacitor 33. When connected in parallel with the respective filter capacitor, each RC series circuit shares the same two nodes as the filter capacitor, providing an alternative current path at high frequencies while the filter capacitor handles lower-frequency noise. This configuration may simplify PCB routing in certain physical layouts.

The resistive element R51, the resistive element R52, and the resistive element R53 have a similar configuration. The capacitor C51, the capacitor C52, and the capacitor C53 have a similar configuration.

One terminal of the resonant inductor 60 is connected to a node to which the plurality of high-side bidirectional switching elements 41, 43, and 45 in the switching circuit 40 are connected. The other terminal of the resonant inductor 60 is connected to one terminal of a primary-side coil 71 of the isolation transformer 70. The other terminal of the primary-side coil 71 of the isolation transformer 70 is connected to a node to which the plurality of low-side bidirectional switching elements 44, 46, and 42 in the switching circuit 40 are connected. The leakage inductance of the primary-side coil 71 of the isolation transformer 70 may be used as the resonant inductor 60. In this case, no discrete resonant inductor component is required, and the resonant inductor 60 shown in FIG. 1 represents the leakage inductance of the primary-side coil 71. This embodiment may reduce the component count and physical footprint of the power conversion circuit 10.

The rectifier circuit 81 is connected to a secondary-side coil 72 of the isolation transformer 70. The rectifier circuit 81 is constituted by a bridge circuit including a plurality of switching elements Q81, Q82, Q83, and Q84.

A high-side output terminal of the rectifier circuit 81 is connected to the high-side DC output terminal POH through the output smoothing inductor 82. A low-side output terminal of the rectifier circuit 81 is connected to the low-side DC output terminal POL.

The output smoothing capacitor 83 is connected between the high-side DC output terminal POH and the low-side DC output terminal POL.

With this configuration, the power conversion circuit 10 converts input three-phase AC power to DC power having a predetermined voltage and a predetermined current and outputs the DC power to the load LD. More specifically, the switching circuit 40 controls ON/OFF (conducting/non-conducting) states of the plurality of switching elements included in the switching circuit 40 as described above, thereby setting a plurality of operating states and sequentially transitioning among the operating states. The plurality of operating states are determined by the ON/OFF combinations of the high-side bidirectional switching elements 41, 43, and 45 and the low-side bidirectional switching elements 44, 46, and 42. In each operating state, at least one high-side bidirectional switching element and at least one low-side bidirectional switching element are in an ON state, and the switching circuit 40 sequentially transitions among these operating states to synthesize a high-frequency AC current from the three-phase input power. Thus, the switching circuit 40 generates an AC current having a high frequency for conversion (on the order of tens to hundreds of kHz) from commercial-frequency AC power, and outputs the AC current to the primary-side coil 71 of the isolation transformer 70 through the resonant inductor 60.

In the secondary-side coil 72 of the isolation transformer 70, an output current corresponding to a coupling coefficient between the primary-side coil 71 and the secondary-side coil 72 is induced. The rectifier circuit 81 rectifies the output current of the isolation transformer 70, and the output smoothing inductor 82 and the output smoothing capacitor 83 smooth the rectified current. Thus, a desired DC voltage and a desired DC current are output to the high-side DC output terminal POH and the low-side DC output terminal POL.

In this configuration, the power conversion circuit 10 achieves, for example, the following functions and effects.

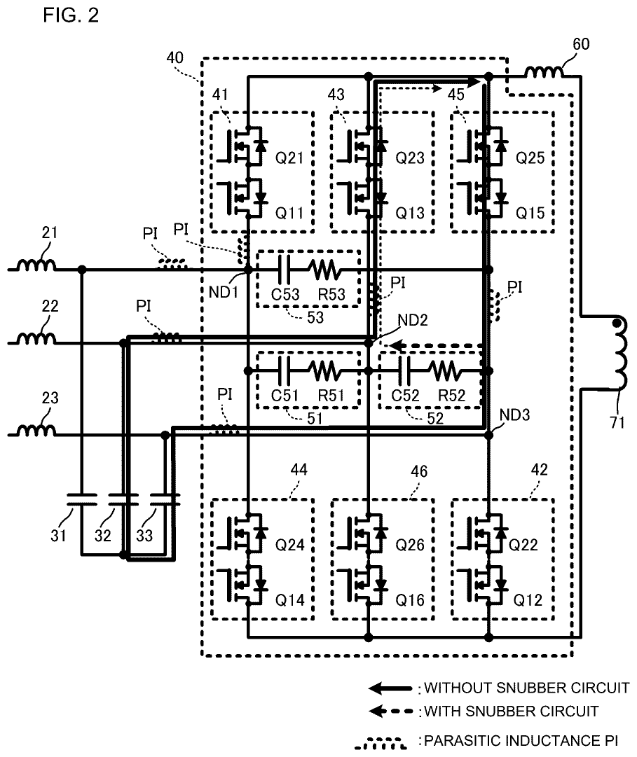

FIG. 2 is a diagram illustrating an example of a switching current path formed in the power conversion circuit according to the embodiment of the present disclosure. FIG. 2 illustrates a switching current path formed when switching from a state (first state) in which the high-side bidirectional switching element 43 and the low-side bidirectional switching element 44 are in an ON (conducting) state and the high-side bidirectional switching elements 41 and 45 and the low-side bidirectional switching elements 46 and 42 are in an OFF (non-conducting) state to a state (second state) in which the high-side bidirectional switching element 45 and the low-side bidirectional switching element 44 are in an ON (conducting) state and the high-side bidirectional switching elements 41 and 43 and the low-side bidirectional switching elements 46 and 42 are in an OFF (non-conducting) state.

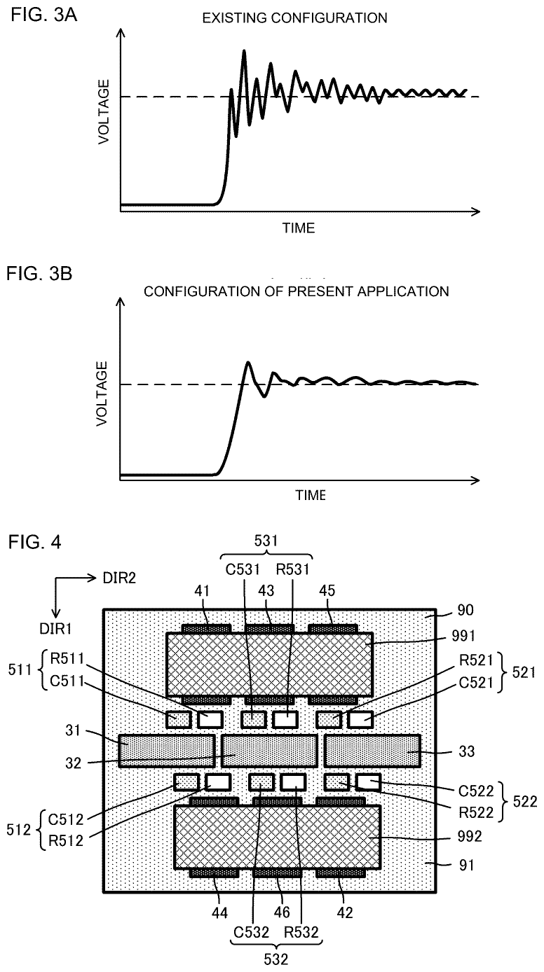

FIGS. 3A and 3B are waveform diagrams illustrating the effect of suppressing voltage ringing. In FIGS. 3A and 3B, the horizontal axis represents time, and the vertical axis represents voltage. The voltage represents the voltage across the switching element Q23 of the high-side bidirectional switching element 43. FIG. 3A illustrates a waveform in an existing configuration, and FIG. 3B illustrates a waveform in the configuration of the present application. The existing configuration is the same as the configuration of the present application except that the existing configuration does not include the plurality of snubber circuits 51 to 53.

As indicated by a solid line in FIG. 2, when switching from the first state to the second state, a transient current associated with switching operation flows in a switching loop formed by the high-side bidirectional switching element 45, the third node ND3, the filter capacitor 33, the filter capacitor 32, the second node ND2, and the high-side bidirectional switching element 43.

In the existing configuration, since the snubber circuit 52 illustrated in FIG. 2 is not included, a transient switching current flows through the filter capacitors 32 and 33.

Here, when the power conversion circuit handles high-voltage and high-current power on the order of kilowatts, noise contained in the input power also increases. In this case, the impedance of each of the plurality of filter capacitors 31 to 33 at the noise frequency may be reduced, i.e., to increase the capacitance of each of the plurality of filter capacitors 31 to 33.

However, as the capacitance of each of the plurality of filter capacitors 31 to 33 is increased, the volume of each of the filter capacitors 31 to 33 increases, thereby increasing the equivalent series inductance (ESL). Furthermore, the increased volume of each of the filter capacitors 31 to 33 makes it difficult to dispose the filter capacitors 31 to 33 close to the switching circuit 40, thereby increasing parasitic inductance PI existing in the switching loop. Thus, as illustrated in FIG. 3A, the surge voltage increases, and voltage ringing continues.

On the other hand, the power conversion circuit 10 according to the embodiment of the present disclosure includes the snubber circuit 52 disposed close to the switching circuit 40. A switching loop is formed by the high-side bidirectional switching element 45, the third node ND3, the snubber circuit 52, the second node ND2, and the high-side bidirectional switching element 43. The snubber circuit 52 reduces the parasitic inductance PI existing in the switching loop, and thus the surge voltage decreases. Furthermore, as indicated by a dashed line in FIG. 2, the switching current flows through the snubber circuit 52, thereby suppressing ringing voltage. Thus, as illustrated in FIG. 3B, voltage ringing is suppressed.

Such functions and effects are achieved when the plurality of high-side bidirectional switching elements 41, 43, and 45 are switched from an ON state to an OFF state while the plurality of low-side bidirectional switching elements 44, 46, and 42 remain in an ON state. Hence, voltage ringing is suppressed not only by the snubber circuit 52 but also by the snubber circuits 51 and 53.

Thus, the power conversion circuit 10 can suppress voltage ringing. Furthermore, the filter capacitors 31, 32, and 33 can be disposed away from the switching circuit 40. As a result, the capacitance of each of the filter capacitors 31, 32, and 33 can be increased, and the power conversion circuit 10 can suppress noise on three-phase AC power lines while suppressing input power loss.

That is, even when the power conversion circuit 10 handles power on the order of kilowatts, the power conversion circuit 10 can achieve both suppression of noise on the three-phase AC power lines and reduction of surge voltage and suppression of voltage ringing generated during switching operation.

In this case, the capacitance of each of the capacitors C51, C52, and C53 constituting the respective snubber circuits 51 to 53 is smaller than the capacitance of each of the filter capacitors 31, 32, and 33. The capacitors C51, C52, and C53 are disposed close to the switching circuit 40. That is, the parasitic inductance PI existing in the switching loop is reduced as compared with a state in which the plurality of snubber circuits 51 to 53 are not included. Thus, the power conversion circuit 10 can further suppress voltage ringing caused by a transient high-frequency component of switching current flowing through the plurality of snubber circuits 51 to 53.

Furthermore, at a transient high frequency of the switching current of the switching circuit 40, the impedance of each of the capacitors C51, C52, and C53 constituting the respective snubber circuits 51 to 53 is lower than the impedance of each of the filter capacitors 31, 32, and 33. That is, the capacitors C51, C52, and C53 constituting the respective snubber circuits 51 to 53 have a lower high-frequency impedance than the filter capacitors 31, 32, and 33. Thus, the power conversion circuit 10 can further suppress voltage ringing caused by the switching current flowing through the plurality of snubber circuits 51 to 53.

Furthermore, the resistive elements R51, R52, and R53 constituting the respective snubber circuits 51 to 53 may each have a resistance value low enough that a transient high-frequency component can flow into the snubber circuits 51 to 53. This makes it easier for the transient high-frequency component to flow into the plurality of snubber circuits 51 to 53, thereby enabling the power conversion circuit 10 to further suppress voltage ringing.

Furthermore, the electrical distance (connection distance) between the snubber circuit 51 and each of the first and second nodes ND1 and ND2 is shorter than the electrical distance (connection distance) between the filter capacitor 31 and each of the first and second nodes ND1 and ND2. The electrical distance (connection distance) between the snubber circuit 52 and each of the second and third nodes ND2 and ND3 is shorter than the electrical distance (connection distance) between the filter capacitor 32 and each of the second and third nodes ND2 and ND3. The electrical distance (connection distance) between the snubber circuit 53 and each of the third and first nodes ND3 and ND1 is shorter than the electrical distance (connection distance) between the filter capacitor 33 and each of the third and first nodes ND3 and ND1.

The electrical distance described here corresponds to the length of a wiring pattern connecting two circuits or circuit elements that are electrically connected to each other. The electrical distance described here corresponds to the length of a wiring pattern, such as a conductive trace on a circuit substrate, connecting two circuits or circuit elements that are electrically connected to each other. A shorter electrical distance results in lower parasitic inductance in the current path between the two elements.

This makes it easier for the transient high-frequency component to flow into the plurality of snubber circuits 51 to 53. Thus, the power conversion circuit 10 can further suppress voltage ringing.

Furthermore, the plurality of snubber circuits 51 may be connected to a position on a high-side bidirectional switching element 41 side of the first node ND1 and to a position on a high-side bidirectional switching element 43 side of the second node ND2. The plurality of snubber circuits 52 may be connected to a position on the high-side bidirectional switching element 43 side of the second node ND2 and to a position on a high-side bidirectional switching element 45 side of the third node ND3. The plurality of snubber circuits 53 may be connected to a position on the high-side bidirectional switching element 45 side of the third node ND3 and to a position on the high-side bidirectional switching element 41 side of the first node ND1.

Furthermore, the plurality of snubber circuits 51 to 53 are not limited to the configuration of the embodiment and may be disposed not only on the high side but also on the low side.

As a result, the power conversion circuit 10 enables the length of a current shunting path between the high-side bidirectional switching element 41 and the high-side bidirectional switching element 43, the length of a current shunting path between the high-side bidirectional switching element 43 and the high-side bidirectional switching element 45, and the length of a current shunting path between the high-side bidirectional switching element 45 and the high-side bidirectional switching element 41 to be shortened. Thus, the power conversion circuit 10 can further suppress voltage ringing.

### Physical Configuration 1 of Power Conversion Circuit

FIG. 4 is a plan view illustrating a first example of the physical configuration of the power conversion circuit according to the embodiment of the present disclosure. FIG. 4 illustrates a portion upstream of the isolation transformer 70 in the circuit configuration illustrated in FIG. 1.

The power conversion circuit illustrated in FIG. 4 differs from the power conversion circuit 10 illustrated in FIG. 1 in that the power conversion circuit includes a snubber circuit 511, a snubber circuit 512, a snubber circuit 521, a snubber circuit 522, a snubber circuit 531, and a snubber circuit 532.

The snubber circuit 511 and the snubber circuit 512 are connected in parallel to constitute the snubber circuit 51. The snubber circuit 511 corresponds to “first RC series circuit”, and the snubber circuit 512 corresponds to “fourth RC series circuit”.

The snubber circuit 521 and the snubber circuit 522 are connected in parallel to constitute the snubber circuit 52. The snubber circuit 521 corresponds to “second RC series circuit”, and the snubber circuit 522 corresponds to “fifth RC series circuit”.

The snubber circuit 531 and the snubber circuit 532 are connected in parallel to constitute the snubber circuit 53. The snubber circuit 531 corresponds to “third RC series circuit”, and the snubber circuit 532 corresponds to “sixth RC series circuit”.

A circuit substrate 90 has a front surface 91, and a first direction DIR1 and a second direction DIR2 that are parallel to the front surface 91 and orthogonal to each other.

The plurality of filter capacitors 31 to 33, the plurality of high-side bidirectional switching elements 41, 43, and 45, the plurality of low-side bidirectional switching elements 42, 44, and 46, a resistive element R511 and a capacitor C511 of the snubber circuit 511, a resistive element R512 and a capacitor C512 of the snubber circuit 512, a resistive element R521 and a capacitor C521 of the snubber circuit 521, a resistive element R522 and a capacitor C522 of the snubber circuit 522, a resistive element R531 and a capacitor C531 of the snubber circuit 531, and a resistive element R532 and a capacitor C532 of the snubber circuit 532 are mounted on the front surface 91 of the circuit substrate 90. These elements may be mounted on one surface of the circuit substrate or may be disposed separately on both surfaces thereof.

The plurality of high-side bidirectional switching elements 41, 43, and 45 are disposed at substantially the same first position in the first direction DIR1. In this case, the high-side bidirectional switching element 41, the high-side bidirectional switching element 43, and the high-side bidirectional switching element 45 are sequentially disposed along the second direction DIR2. A heat sink 991 is disposed on the top surfaces of the plurality of high-side bidirectional switching elements 41, 43, and 45.

The plurality of low-side bidirectional switching elements 42, 44, and 46 are disposed at substantially the same second position in the first direction DIR1. In this case, the low-side bidirectional switching element 44, the low-side bidirectional switching element 46, and the low-side bidirectional switching element 42 are sequentially disposed along the second direction DIR2. A heat sink 992 is disposed on the top surfaces of the plurality of low-side bidirectional switching elements 42, 44, and 46.

In the first direction DIR1, a region (first position) in which the plurality of high-side bidirectional switching elements 41, 43, and 45 are disposed and a region (second position) in which the plurality of low-side bidirectional switching elements 42, 44, and 46 are disposed are spaced apart from each other by a predetermined distance.

In the second direction DIR2, the position of the high-side bidirectional switching element 41 coincides with the position of the low-side bidirectional switching element 44. In the second direction DIR2, the position of the high-side bidirectional switching element 43 coincides with the position of the low-side bidirectional switching element 46.

In the first direction DIR1, the plurality of filter capacitors 31, 32, and 33 are disposed at a third position between the region (first position) in which the plurality of high-side bidirectional switching elements 41, 43, and 45 are disposed and the region (second position) in which the plurality of low-side bidirectional switching elements 42, 44, and 46 are disposed. In this case, the filter capacitor 31, the filter capacitor 32, and the filter capacitor 33 are sequentially disposed in the second direction DIR2.

In the first direction DIR1, the resistive element R511 and the capacitor C511 of the snubber circuit 511, the resistive element R521 and the capacitor C521 of the snubber circuit 521, and the resistive element R531 and the capacitor C531 of the snubber circuit 531 are disposed between the region (first position) in which the plurality of high-side bidirectional switching elements 41, 43, and 45 are disposed and the region (third position) in which the plurality of filter capacitors 31 to 33 are disposed. In this case, the snubber circuit 511, the snubber circuit 531, and the snubber circuit 521 are sequentially disposed along the second direction DIR2.

In the first direction DIR1, the resistive element R512 and the capacitor C512 of the snubber circuit 512, the resistive element R522 and the capacitor C522 of the snubber circuit 522, and the resistive element R532 and the capacitor C532 of the snubber circuit 532 are disposed between the region (second position) in which the plurality of low-side bidirectional switching elements 42, 44, and 46 are disposed and the region (third position) in which the plurality of filter capacitors 31 to 33 are disposed. In this case, the snubber circuit 512, the snubber circuit 532, and the snubber circuit 522 are sequentially disposed along the second direction DIR2.

With this configuration, the electrical distances between the plurality of snubber circuits 511, 531, and 521 and the plurality of high-side bidirectional switching elements 41, 43, and 45 can easily be made shorter than the electrical distances between the plurality of filter capacitors 31 to 33 and the plurality of high-side bidirectional switching elements 41, 43, and 45.

Furthermore, the electrical distances between the plurality of snubber circuits 512, 532, and 522 and the plurality of low-side bidirectional switching elements 42, 44, and 46 can easily be made shorter than the electrical distances between the plurality of filter capacitors 31 to 33 and the plurality of low-side bidirectional switching elements 42, 44, and 46.

This configuration also enables the plurality of snubber circuits to be connected in close proximity to the plurality of high-side bidirectional switching elements 41, 43, and 45 and in close proximity to the plurality of low-side bidirectional switching elements 42, 44, and 46, respectively. As a result, the distance between the plurality of high-side bidirectional switching elements 41, 43, and 45 and the plurality of low-side bidirectional switching elements 42, 44, and 46 can be increased, thereby making it possible to avoid concentration of heat sources.

### Physical Configuration 2 of Power Conversion Circuit

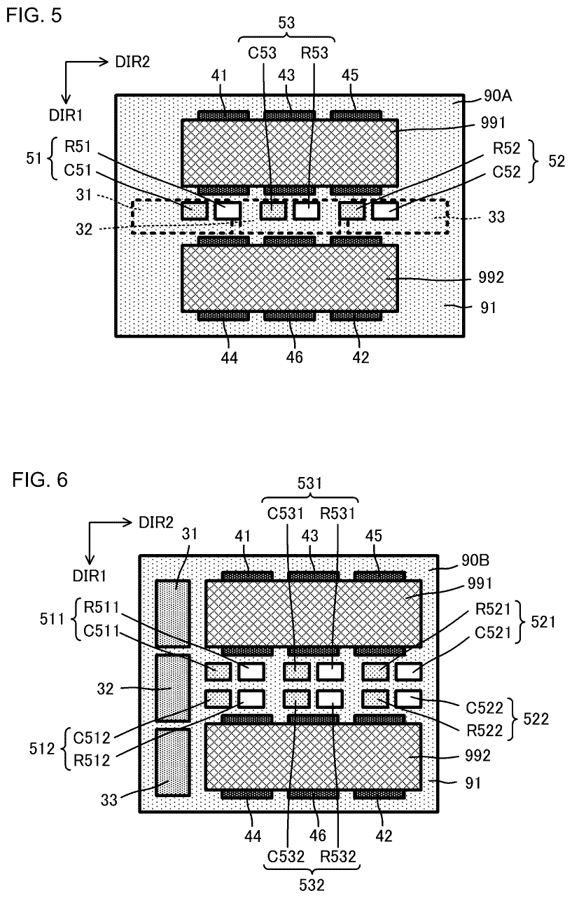

FIG. 5 is a plan view illustrating a second example of the physical configuration of the power conversion circuit according to the embodiment of the present disclosure. FIG. 5 illustrates a portion upstream of the isolation transformer 70 in the circuit configuration illustrated in FIG. 1.

A circuit substrate 90A has the front surface 91, and the first direction DIR1 and the second direction DIR2 that are parallel to the front surface 91 and orthogonal to each other.

The plurality of high-side bidirectional switching elements 41, 43, and 45, the plurality of low-side bidirectional switching elements 42, 44, and 46, the resistive element R51 and the capacitor C51 of the snubber circuit 51, the resistive element R52 and the capacitor C52 of the snubber circuit 52, the resistive element R53 and the capacitor C53 of the snubber circuit 53, and the resistive element R532 and the capacitor C532 of the snubber circuit 532 are mounted on the front surface 91 of the circuit substrate 90A.

The plurality of filter capacitors 31 to 33 are mounted on the back surface of the circuit substrate 90A.

The plurality of high-side bidirectional switching elements 41, 43, and 45 are disposed at substantially the same first position in the first direction DIR1. In this case, the high-side bidirectional switching element 41, the high-side bidirectional switching element 43, and the high-side bidirectional switching element 45 are sequentially disposed along the second direction DIR2. The heat sink 991 is disposed on the top surfaces of the plurality of high-side bidirectional switching elements 41, 43, and 45.

The plurality of low-side bidirectional switching elements 42, 44, and 46 are disposed at substantially the same second position in the first direction DIR1. As used herein, “substantially the same position in the first direction DIR1” means within a positional tolerance consistent with standard PCB mounting practices, such that the electrical distances between the respective elements and the snubber circuits remain materially equivalent. In this case, the low-side bidirectional switching element 44, the low-side bidirectional switching element 46, and the low-side bidirectional switching element 42 are sequentially disposed along the second direction DIR2. The heat sink 992 is disposed on the top surfaces of the plurality of low-side bidirectional switching elements 42, 44, and 46.

In the first direction DIR1, the region (first position) in which the plurality of high-side bidirectional switching elements 41, 43, and 45 are disposed and the region (second position) in which the plurality of low-side bidirectional switching elements 42, 44, and 46 are disposed are spaced apart from each other by a predetermined distance.

In the second direction DIR2, the position of the high-side bidirectional switching element 41 coincides with the position of the low-side bidirectional switching element 44. In the second direction DIR2, the position of the high-side bidirectional switching element 43 coincides with the position of the low-side bidirectional switching element 46.

In the first direction DIR1, the plurality of filter capacitors 31, 32, and 33 are disposed at the third position between the region (first position) in which the plurality of high-side bidirectional switching elements 41, 43, and 45 are disposed and the region (second position) in which the plurality of low-side bidirectional switching elements 42, 44, and 46 are disposed. In this case, the filter capacitor 31, the filter capacitor 32, and the filter capacitor 33 are sequentially disposed in the second direction DIR2.

In the first direction DIR1, the resistive element R51 and the capacitor C51 of the snubber circuit 51, the resistive element R52 and the capacitor C52 of the snubber circuit 52, and the resistive element R53 and the capacitor C53 of the snubber circuit 53 are disposed between the region (first position) in which the plurality of high-side bidirectional switching elements 41, 43, and 45 are disposed and the region (second position) in which the plurality of low-side bidirectional switching elements 42, 44, and 46 are disposed. In this case, the snubber circuit 51, the snubber circuit 53, and the snubber circuit 52 are sequentially disposed along the second direction DIR2.

In this case, the snubber circuits 51 to 53 may be disposed at a position closer to the first position than to the second position in the first direction DIR1.

With this configuration, the electrical distances between the plurality of snubber circuits 51, 53, and 52 and the plurality of high-side bidirectional switching elements 41, 43, and 45, and the electrical distances between the plurality of snubber circuits 51, 53, and 52 and the plurality of low-side bidirectional switching elements 42, 44, and 46 can shorten the electrical distances between the plurality of filter capacitors 31 to 33 and the plurality of high-side bidirectional switching elements 41, 43, and 45, and the electrical distances between the plurality of filter capacitors 31 to 33 and the plurality of low-side bidirectional switching elements 42, 44, and 46.

Furthermore, the plurality of snubber circuits 512, 532, and 522 are disposed closer to the plurality of low-side bidirectional switching elements 42, 44, and 46 than the plurality of filter capacitors 31 to 33 are. As a result, the electrical distances (connection distances) between the plurality of low-side bidirectional switching elements 42, 44, and 46 and the plurality of snubber circuits 512, 532, and 522 can easily be made shorter than the electrical distances (connection distances) between the plurality of low-side bidirectional switching elements 42, 44, and 46 and the plurality of filter capacitors 31 to 33.

Additionally, the planar area of the circuit substrate 90A can be reduced by disposing (mounting) the plurality of filter capacitors 31 to 33, which are larger than the capacitors C51, C52, and C53 constituting the respective snubber circuits 51 to 53, on the back surface of the circuit substrate 90A at positions overlapping the plurality of snubber circuits 51 to 53.

### Physical Configuration 3 of Power Conversion Circuit

FIG. 6 is a plan view illustrating a third example of the physical configuration of the power conversion circuit according to the embodiment of the present disclosure. FIG. 6 illustrates a portion upstream of the isolation transformer 70 in the circuit configuration illustrated in FIG. 1.

The configuration illustrated in FIG. 6 differs from the configuration illustrated in FIG. 4 in the positions at which the plurality of filter capacitors 31 to 33 are disposed. Other portions of the configuration illustrated in FIG. 6 are similar to those of the configuration illustrated in FIG. 4, and description of similar portions is omitted.

The power conversion circuit illustrated in FIG. 6 includes a circuit substrate 90B. In the second direction DIR2, the plurality of filter capacitors 31, 32, and 33 are disposed adjacent to the region (first position) in which the plurality of high-side bidirectional switching elements 41, 43, and 45 are disposed, the region (second position) in which the plurality of low-side bidirectional switching elements 42, 44, and 46 are disposed, and the positions at which the plurality of snubber circuits 511, 512, 521, 522, 531, and 532 are disposed.

With this configuration, the electrical distances between the plurality of snubber circuits 511, 531, and 521 and the plurality of high-side bidirectional switching elements 41, 43, and 45 can easily be made shorter than the electrical distances between the plurality of filter capacitors 31 to 33 and the plurality of high-side bidirectional switching elements 41, 43, and 45. Furthermore, the electrical distances between the plurality of snubber circuits 512, 532, and 522 and the plurality of low-side bidirectional switching elements 42, 44, and 46 can easily be made shorter than the electrical distances between the plurality of filter capacitors 31 to 33 and the plurality of low-side bidirectional switching elements 42, 44, and 46.

Furthermore, as illustrated in this configuration, as long as the plurality of snubber circuits 511, 512, 521, 522, 531, and 532 are disposed between the first position and the second position, flexibility in the positions of the plurality of filter capacitors 31 to 33 can be improved. That is, a power conversion circuit that achieves the above-described electrical functions and effects can be configured in accordance with physical design requirements of the power conversion circuit, such as overall board dimensions, component clearance requirements, or thermal management constraints.
<1> A power conversion circuit comprising:
a switching circuit including a first series circuit, a second series circuit, and a third series circuit connected in parallel, the first series circuit including a first high-side bidirectional switching element and a first low-side bidirectional switching element, the second series circuit including a second high-side bidirectional switching element and a second low-side bidirectional switching element, and the third series circuit including a third high-side bidirectional switching element and a third low-side bidirectional switching element;
a first filter capacitor connected to the first series circuit;
a second filter capacitor connected to the second series circuit;
a third filter capacitor connected to the third series circuit;
an inductor and a primary-side coil of a transformer that are connected to respective output terminals of the switching circuit;
a rectifier circuit connected to a secondary-side coil of the transformer;
an output smoothing circuit connected to the rectifier circuit; and
a first RC series circuit, a second RC series circuit, and a third RC series circuit,
wherein the first filter capacitor is connected to a first node at which the first high-side bidirectional switching element and the first low-side bidirectional switching element in the first series circuit are connected to each other,
wherein the second filter capacitor is connected to a second node at which the second high-side bidirectional switching element and the second low-side bidirectional switching element in the second series circuit are connected to each other,
wherein the third filter capacitor is connected to a third node at which the third high-side bidirectional switching element and the third low-side bidirectional switching element in the third series circuit are connected to each other,
wherein the first RC series circuit is connected between the first node and the second node,
wherein the second RC series circuit is connected between the second node and the third node, and
wherein the third RC series circuit is connected between the third node and the first node.
<2> The power conversion circuit according to <1>,
wherein an electrical distance between the first RC series circuit and each of the first node and the second node is shorter than an electrical distance between the first node and the first filter capacitor and an electrical distance between the second node and the second filter capacitor,
wherein an electrical distance between the second RC series circuit and each of the second node and the third node is shorter than the electrical distance between the second node and the second filter capacitor and an electrical distance between the third node and the third filter capacitor, and
wherein an electrical distance between the third RC series circuit and each of the third node and the first node is shorter than the electrical distance between the third node and the third filter capacitor and the electrical distance between the second node and the second filter capacitor.
<3> The power conversion circuit according to <1> or <2>,
wherein capacitances of a plurality of capacitors constituting the respective first, second, and third RC series circuits are lower than capacitances of the first filter capacitor, the second filter capacitor, and the third filter capacitor.
<4> The power conversion circuit according to any of <1> to <3>,
wherein, at a switching frequency of the switching circuit,
impedances of a plurality of capacitors constituting the respective first, second, and third RC series circuits are lower than impedances of the first filter capacitor, the second filter capacitor, and the third filter capacitor.
<5> The power conversion circuit according to any of <1> to <4>,
wherein the first RC series circuit is connected in parallel with the first filter capacitor,
wherein the second RC series circuit is connected in parallel with the second filter capacitor, and
wherein the third RC series circuit is connected in parallel with the third filter capacitor.
<6> The power conversion circuit according to any of <1> to <5>, further comprising
a fourth RC series circuit, a fifth RC series circuit, and a sixth RC series circuit,
wherein the first RC series circuit is connected to a position on a first high-side bidirectional switching element side of the first node and to a position on a second high-side bidirectional switching element side,
wherein the second RC series circuit is connected to a position on the second high-side bidirectional switching element side of the second node and to a position on a third high-side bidirectional switching element side,
wherein the third RC series circuit is connected to a position on the third high-side bidirectional switching element side of the third node and to a position on the first high-side bidirectional switching element side,
wherein the fourth RC series circuit is connected to a position on a first low-side bidirectional switching element side of the first node and to a position on a second low-side bidirectional switching element side,
wherein the fifth RC series circuit is connected to a position on the second low-side bidirectional switching element side of the second node and to a position on a third low-side bidirectional switching element side, and
wherein the sixth RC series circuit is connected to a position on the third low-side bidirectional switching element side of the third node and to a position on the first low-side bidirectional switching element side.
<7> The power conversion circuit according to any of <1> to <5>, comprising
a circuit substrate having a first direction and a second direction that are orthogonal to each other,
wherein, in the first direction,
the first high-side bidirectional switching element, the second high-side bidirectional switching element, and the third high-side bidirectional switching element are mounted on the circuit substrate at substantially the same first position,
the first low-side bidirectional switching element, the second low-side bidirectional switching element, and the third low-side bidirectional switching element are mounted on the circuit substrate at substantially the same second position,
the first filter capacitor, the second filter capacitor, and the third filter capacitor are mounted on the circuit substrate at a third position between the first position and the second position, and
a plurality of resistive elements and a plurality of capacitors constituting the respective first, second, and third RC series circuits are mounted on the circuit substrate between the first position and the third position or between the second position and the third position.
<8> The power conversion circuit according to <6>, comprising
a circuit substrate having a first direction and a second direction that are orthogonal to each other,
wherein, in the first direction,
the first high-side bidirectional switching element, the second high-side bidirectional switching element, and the third high-side bidirectional switching element are mounted on the circuit substrate at substantially the same first position,
the first low-side bidirectional switching element, the second low-side bidirectional switching element, and the third low-side bidirectional switching element are mounted on the circuit substrate at substantially the same second position,
the first filter capacitor, the second filter capacitor, and the third filter capacitor are mounted on the circuit substrate at a third position between the first position and the second position,
a plurality of resistive elements and a plurality of capacitors constituting the respective first, second, and third RC series circuits are mounted on the circuit substrate between the first position and the third position, and
a plurality of resistive elements and a plurality of capacitors constituting the respective fourth, fifth, and sixth RC series circuits are mounted on the circuit substrate between the second position and the third position.

### REFERENCE SIGNS LIST

10 power conversion circuit
21, 22, 23 filter inductor
31, 32, 33 filter capacitor
40 switching circuit
41, 43, 45 high-side bidirectional switching element
42, 44, 46 low-side bidirectional switching element
51, 52, 53, 511, 512, 521, 522, 531, 532 snubber circuit
60 resonant inductor
70 isolation transformer
71 primary-side coil
72 secondary-side coil
80 three-phase AC power supply
81 rectifier circuit
82 output smoothing inductor
83 output smoothing capacitor
90, 90A, 90B circuit substrate
91 front surface
991, 992 heat sink
C51, C511, C512, C52, C521, C522, C53, C531, C532 capacitor
DIR1 first direction
DIR2 second direction
LD load
ND1 first node
ND2 second node
ND3 third node
PI1, PI2, PI3 input terminal
POH high-side DC output terminal
POL low-side DC output terminal
Q11, Q12, Q13, Q14, Q15, Q16, Q21, Q22, Q23, Q24, Q25, Q26, Q81, Q82, Q83, Q84 switching element
R51, R511, R512, R52, R521, R522, R53, R531, R532 resistive element

1. A power conversion circuit comprising:
a switching circuit including a first series circuit, a second series circuit, and a third series circuit connected in parallel, the first series circuit including a first high-side bidirectional switching element and a first low-side bidirectional switching element, the second series circuit including a second high-side bidirectional switching element and a second low-side bidirectional switching element, and the third series circuit including a third high-side bidirectional switching element and a third low-side bidirectional switching element;
a first filter capacitor connected to the first series circuit;
a second filter capacitor connected to the second series circuit;
a third filter capacitor connected to the third series circuit;
an inductor and a primary-side coil of a transformer that are connected to respective output terminals of the switching circuit;
a rectifier circuit connected to a secondary-side coil of the transformer;
an output smoothing circuit connected to the rectifier circuit; and
a first RC series circuit, a second RC series circuit, and a third RC series circuit,
wherein the first filter capacitor is connected to a first node at which the first high-side bidirectional switching element and the first low-side bidirectional switching element in the first series circuit are connected to each other,
wherein the second filter capacitor is connected to a second node at which the second high-side bidirectional switching element and the second low-side bidirectional switching element in the second series circuit are connected to each other,
wherein the third filter capacitor is connected to a third node at which the third high-side bidirectional switching element and the third low-side bidirectional switching element in the third series circuit are connected to each other,
wherein the first RC series circuit is connected between the first node and the second node,
wherein the second RC series circuit is connected between the second node and the third node, and
wherein the third RC series circuit is connected between the third node and the first node.

2. The power conversion circuit according to claim 1,
wherein an electrical distance between the first RC series circuit and each of the first node and the second node is shorter than an electrical distance between the first node and the first filter capacitor and an electrical distance between the second node and the second filter capacitor,
wherein an electrical distance between the second RC series circuit and each of the second node and the third node is shorter than the electrical distance between the second node and the second filter capacitor and an electrical distance between the third node and the third filter capacitor, and
wherein an electrical distance between the third RC series circuit and each of the third node and the first node is shorter than the electrical distance between the third node and the third filter capacitor and the electrical distance between the second node and the second filter capacitor.

3. The power conversion circuit according to claim 1,
wherein capacitances of a plurality of capacitors constituting the respective first, second, and third RC series circuits are lower than capacitances of the first filter capacitor, the second filter capacitor, and the third filter capacitor.

4. The power conversion circuit according to claim 1,
wherein, at a switching frequency of the switching circuit,
impedances of a plurality of capacitors constituting the respective first, second, and third RC series circuits are lower than impedances of the first filter capacitor, the second filter capacitor, and the third filter capacitor.

5. The power conversion circuit according to claim 1,
wherein the first RC series circuit is connected in parallel with the first filter capacitor,
wherein the second RC series circuit is connected in parallel with the second filter capacitor, and
wherein the third RC series circuit is connected in parallel with the third filter capacitor.

6. The power conversion circuit according to claim 1, further comprising
a fourth RC series circuit, a fifth RC series circuit, and a sixth RC series circuit,
wherein the first RC series circuit is connected to a position on a first high-side bidirectional switching element side of the first node and to a position on a second high-side bidirectional switching element side of the second node,
wherein the second RC series circuit is connected to a position on the second high-side bidirectional switching element side of the second node and to a position on a third high-side bidirectional switching element side of the third node,
wherein the third RC series circuit is connected to a position on the third high-side bidirectional switching element side of the third node and to a position on the first high-side bidirectional switching element side of the first node,
wherein the fourth RC series circuit is connected to a position on a first low-side bidirectional switching element side of the first node and to a position on a second low-side bidirectional switching element side of the second node,
wherein the fifth RC series circuit is connected to a position on the second low-side bidirectional switching element side of the second node and to a position on a third low-side bidirectional switching element side of the third node, and
wherein the sixth RC series circuit is connected to a position on the third low-side bidirectional switching element side of the third node and to a position on the first low-side bidirectional switching element side of the first node.

7. The power conversion circuit according to claim 1, comprising
a circuit substrate having a first direction and a second direction that are orthogonal to each other,
wherein, in the first direction,
the first high-side bidirectional switching element, the second high-side bidirectional switching element, and the third high-side bidirectional switching element are mounted on the circuit substrate at substantially the same first position,
the first low-side bidirectional switching element, the second low-side bidirectional switching element, and the third low-side bidirectional switching element are mounted on the circuit substrate at substantially the same second position,
the first filter capacitor, the second filter capacitor, and the third filter capacitor are mounted on the circuit substrate at a third position between the first position and the second position, and
a plurality of resistive elements and a plurality of capacitors constituting the respective first, second, and third RC series circuits are mounted on the circuit substrate between the first position and the third position or between the second position and the third position.

8. The power conversion circuit according to claim 6, further comprising
a circuit substrate having a first direction and a second direction that are orthogonal to each other,
wherein, in the first direction,
the first high-side bidirectional switching element, the second high-side bidirectional switching element, and the third high-side bidirectional switching element are mounted on the circuit substrate at substantially the same first position,
the first low-side bidirectional switching element, the second low-side bidirectional switching element, and the third low-side bidirectional switching element are mounted on the circuit substrate at substantially the same second position,
the first filter capacitor, the second filter capacitor, and the third filter capacitor are mounted on the circuit substrate at a third position between the first position and the second position,
a plurality of resistive elements and a plurality of capacitors constituting the respective first, second, and third RC series circuits are mounted on the circuit substrate between the first position and the third position, and
a plurality of resistive elements and a plurality of capacitors constituting the respective fourth, fifth, and sixth RC series circuits are mounted on the circuit substrate between the second position and the third position.

9. The power conversion circuit according to claim 1, wherein the first RC series circuit, the second RC series circuit, and the third RC series circuit are each positioned on a circuit substrate at electrical distances from the respective nodes that are shorter than the electrical distances from the respective filter capacitors to the respective nodes.

10. The power conversion circuit according to claim 1, wherein capacitances of capacitors constituting the respective first, second, and third RC series circuits are lower than capacitances of the first filter capacitor, the second filter capacitor, and the third filter capacity--or, and wherein, at a switching frequency of the switching circuit, impedances of the capacitors constituting the respective first, second, and third RC series circuits are lower than impedances of the first filter capacitor, the second filter capacitor, and the third filter capacitor.

11. The power conversion circuit according to claim 1, wherein the first filter capacitor, the second filter capacitor, and the third filter capacitor are star-connected.

12. The power conversion circuit according to claim 1, further comprising a first filter inductor connected between a first input terminal and the first node, a second filter inductor connected between a second input terminal and the second node, and a third filter inductor connected between a third input terminal and the third node.

13. The power conversion circuit according to claim 6, wherein the first RC series circuit and the fourth RC series circuit are connected in parallel between the first node and the second node, the second RC series circuit and the fifth RC series circuit are connected in parallel between the second node and the third node, and the third RC series circuit and the sixth RC series circuit are connected in parallel between the third node and the first node.

14. The power conversion circuit according to claim 7, wherein the first filter capacitor, the second filter capacitor, and the third filter capacitor are mounted on a back surface of the circuit substrate at positions overlapping the first RC series circuit, the second RC series circuit, and the third RC series circuit when viewed from a direction normal to the circuit substrate.

15. A method of suppressing voltage ringing in a three-phase power conversion circuit, the method comprising:
providing a switching circuit including a first series circuit, a second series circuit, and a third series circuit connected in parallel, each series circuit including a high-side bidirectional switching element and a low-side bidirectional switching element connected in series;
connecting a first filter capacitor to a first node of the first series circuit, a second filter capacitor to a second node of the second series circuit, and a third filter capacitor to a third node of the third series circuit, each node being a midpoint connection between the respective high-side and low-side bidirectional switching elements;
connecting a first RC series circuit between the first node and the second node, a second RC series circuit between the second node and the third node, and a third RC series circuit between the third node and the first node; and
during a switching transition of the switching circuit, diverting a transient high-frequency switching current through at least one of the first RC series circuit, the second RC series circuit, and the third RC series circuit to suppress voltage ringing across the bidirectional switching elements.

16. The method according to claim 15, wherein the transient high-frequency switching current flows through the RC series circuit connected between a node associated with a switching element transitioning from an ON state to an OFF state and a node associated with a switching element remaining in an ON state.

17. The method according to claim 15, wherein each of the first RC series circuit, the second RC series circuit, and the third RC series circuit has a capacitance lower than a capacitance of the respective filter capacitor connected to the same node.

18. A power conversion apparatus comprising:
a circuit substrate;
a switching circuit mounted on the circuit substrate and including a first high-side bidirectional switching element, a second high-side bidirectional switching element, a third high-side bidirectional switching element, a first low-side bidirectional switching element, a second low-side bidirectional switching element, and a third low-side bidirectional switching element, wherein the first high-side bidirectional switching element and the first low-side bidirectional switching element are connected in series at a first node, the second high-side bidirectional switching element and the second low-side bidirectional switching element are connected in series at a second node, and the third high-side bidirectional switching element and the third low-side bidirectional switching element are connected in series at a third node;
a first filter capacitor connected to the first node, a second filter capacitor connected to the second node, and a third filter capacitor connected to the third node;
a first snubber circuit comprising a first resistor and a first capacitor connected in series between the first node and the second node;
a second snubber circuit comprising a second resistor and a second capacitor connected in series between the second node and the third node;
a third snubber circuit comprising a third resistor and a third capacitor connected in series between the third node and the first node;
an isolation transformer having a primary-side coil and a secondary-side coil;
an inductor connected between an output of the switching circuit and the primary-side coil;
a rectifier circuit connected to the secondary-side coil; and
an output smoothing circuit connected to the rectifier circuit,
wherein the first snubber circuit, the second snubber circuit, and the third snubber circuit are mounted on the circuit substrate at positions closer to the switching circuit than the first filter capacitor, the second filter capacitor, and the third filter capacitor are to the switching circuit.

19. The power conversion apparatus according to claim 18, wherein each of the first snubber circuit, the second snubber circuit, and the third snubber circuit has a capacitance lower than a capacitance of the respective filter capacitor connected to the same node, and wherein an impedance of each snubber circuit capacitor at a switching frequency of the switching circuit is lower than an impedance of the respective filter capacitor at the switching frequency.

20. The power conversion apparatus according to claim 18, further comprising a fourth snubber circuit, a fifth snubber circuit, and a sixth snubber circuit, wherein the first snubber circuit and the fourth snubber circuit are each positioned on a high-side bidirectional switching element side and a low-side bidirectional switching element side of the first node, respectively, the second snubber circuit and the fifth snubber circuit are each positioned on a high-side bidirectional switching element side and a low-side bidirectional switching element side of the second node, respectively, and the third snubber circuit and the sixth snubber circuit are each positioned on a high-side bidirectional switching element side and a low-side bidirectional switching element side of the third node, respectively.
